(19) United States
(12) Patent Application Publication
(10) Pub. No.: US 2025/0280970 A1
(43) Pub. Date: Sep. 11, 2025

(54) CAMERA DISPLAY SYSTEM

(71) Applicant: SENNCO SOLUTIONS INC., PLAINFIELD, IL (US)

(72) Inventor: Daniel L. HORVATH, Plainfield, IL (US)

(73) Assignee: SENNCO SOLUTIONS INC., PLAINFIELD, IL (US)

(21) Appl. No.: 19/050,740

(22) Filed: Feb. 11, 2025

Related U.S. Application Data
(60) Provisional application No. 63/553,823, filed on Feb. 15, 2024.

(51) Int. Cl. A47F 3/00; A47F 5/00; G03B 17/56

(52) U.S. Cl. CPC A47F 3/002; A47F 5/0043; G03B 17/561

(57) ABSTRACT

A camera display system for mounting on a retail shelf, and method of use. The camera display system includes a base, a mount configured to attach to a camera, wherein the mount is connectable and is lockable with respect to the base, and a camera shroud positioned over one or more releases of the camera. The camera shroud is affixed to the base and/or the mount. The mount is a rail mount that slides into a camera rail of or attached to the base. The system can be installed on existing retail security posts used for electronics.

### CROSS REFERENCE TO RELATED APPLICATION

This application claims the benefit of U.S. Provisional Application, Ser. No. 63/553,823, filed on 15 Feb. 2024. The co-pending provisional application is hereby incorporated by reference herein in its entirety and is made a part hereof, including but not limited to those portions which specifically appear hereinafter.

### BACKGROUND OF THE INVENTION

### Field of the Invention

This invention relates generally to a display system for cameras.

### Description of Prior Art

Retailers need to balance customer access to product with the risk of retail theft of high value inventory from display shelves. Thieves target retail stores to remove valuable products and later return them for cash or sell them outright. And yet, legitimate potential customers would like to hold, feel, and manipulate retail items before making purchasing decisions.

Draconian solutions include locking down high value product in vaults or cabinets that require store personnel to unlock and physically provide the product to the consumer. Other solutions include security wires and/or post systems that physically connect the product to store shelves or each other, sometimes with wired alarm systems that activate when a product is separated from a post or a tether. Overly restrictive solutions tend to discourage customers from purchases because of the extra effort and time required to examine and attain a product for purchase.

One area of particular concern is products like small electronics, particular photo and video cameras and similar small high value products that a consumer may want to engage with directly in order to gauge a potential purchase. Such items require presentation to the consumer in a way that permits engagement without allowing the consumer to relocate the product from the display. Cameras may pose a particular challenge because sophisticated DSLR cameras often include removable components like batteries, memory cards and lenses that must likewise be secured without obstructing access to other operative features of the camera.

A need therefore exists in a retail system permit consumer engagement with a sample product while maintaining inventory under lock and key solutions.

### SUMMARY OF THE INVENTION

The invention generally relates to a camera display system that permits access to operative components of the camera while deterring theft of the camera body as well as accessories like lenses, batteries, and memory cards. Such a camera display system is preferably mountable to a retail shelf within physical access to retail customers.

The general object of the invention can be attained, at least in part, through a camera display system for mounting on a retail shelf that includes a rail mount, a camera rail, and/or a camera shroud. The subject system may then be mounted on available security posts with or without security tethers. This permits use and inspection of the mounted camera while maintaining secure attachment of all components of the camera.

The invention includes a camera display system with a base and a mount configured to attach to a camera, wherein the mount is connectable and is lockable with respect to the base. A camera shroud is positioned over one or more releases of the camera. The camera shroud is affixed to the base and/or the mount, generally extending upward toward the camera.

The invention further includes a camera display system with a base including a camera rail, and a rail mount configured to attach to a camera. The rail mount is slideable with respect to the camera rail and lockable with respect to the base and the rail. A camera shroud is again desirably positioned over one or more releases of the camera, and the camera shroud is affixed or secured to one or more of the camera rail, the base, and the rail mount.

In embodiments, the camera shroud is secured between the camera and the rail mount. The shroud can be sandwiched between the components. Each of the shroud and the rail mount can include at least one opening for a security screw configured to insert into the threaded tripod connection on the camera. The camera shroud can also include a curved receiver configured to receive a lens of a camera.

In embodiments, the base or camera rail includes a channel, and the rail mount includes a rail configured to fit (e.g., slide) into the channel. Desirably, the base or camera rail includes opposing channels on opposing sides, and the rail mount includes opposing rails, each configured to fit into one of the opposing channels.

In embodiments, one of the base and the rail mount includes a lock, and an other of the base and the mount includes a lock receiver. The lock can be a pin lock and the lock receiver can be an opening through which the pin lock extends. The extended pin keeps the rail mount from being removed (e.g., slid) from the base/camera rail. In embodiments, the base or camera rail includes a channel, the mount includes a rail that slides into the channel, and an end of the mount includes an elbow including the lock receiver. The elbow extends or wraps around an end portion of the base and/or camera rail to be in line with the lock.

Other objects and advantages will be apparent to those skilled in the art from the following detailed description taken in conjunction with the appended claims and drawings.

### BRIEF DESCRIPTION OF THE DRA WINGS

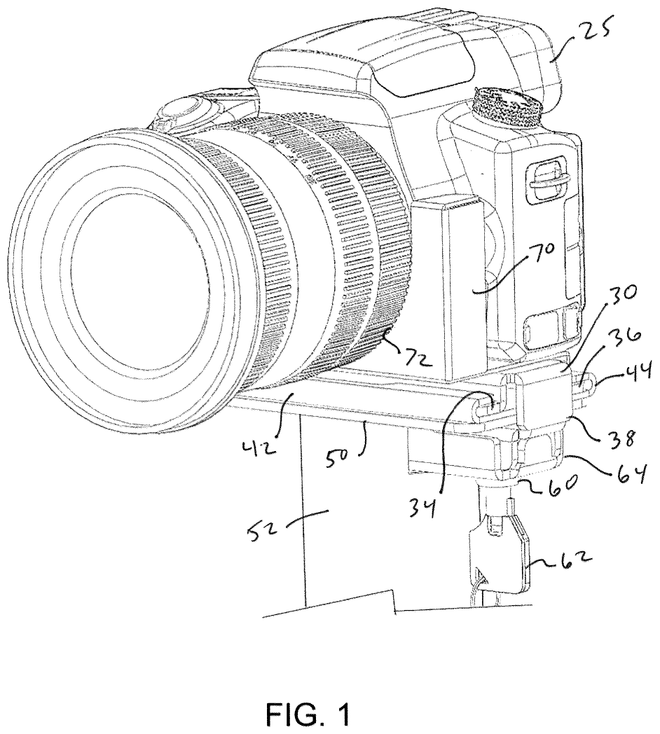

FIG. 1 shows a front perspective view of a camera display system according to one embodiment of the invention;

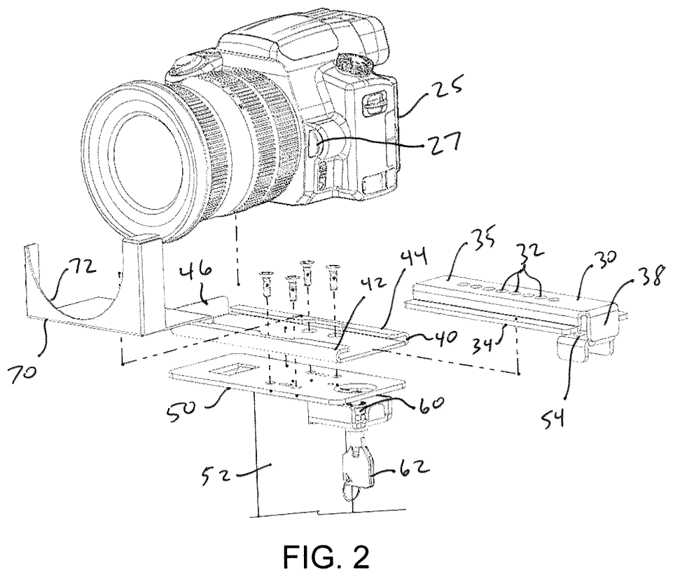

FIG. 2 shows a partially exploded perspective view of the camera display system shown in FIG. 1;

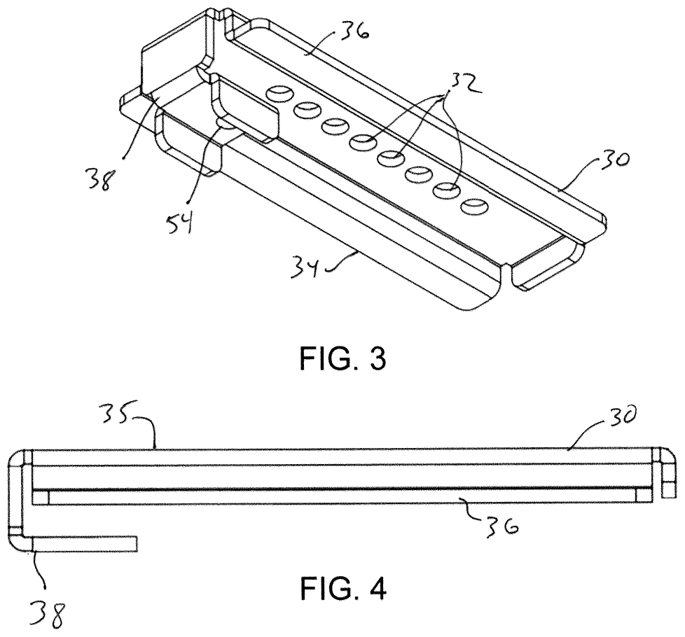

FIG. 3 shows a perspective view of a camera rail mount according to the embodiment shown in FIG. 1;

FIG. 4 shows a side view of the camera rail mount shown in FIG. 3;

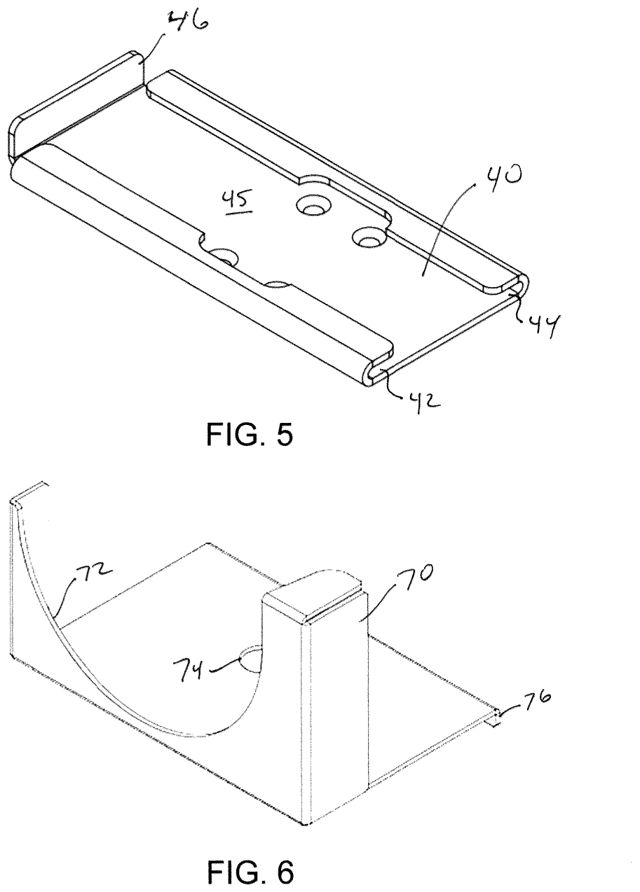

FIG. 5 shows a perspective view of a camera rail according to the embodiment shown in FIG. 1; and

FIG. 6 shows a perspective view of a camera shroud according to the embodiment shown in FIG. 1.

### DETAILED DESCRIPTION OF THE INVENTION

The present invention provides a system including a camera display system that is mountable relative to a retail shelf to prevent theft of the camera and its various components. Although a DSLR camera is shown herein, other electronic devices including action cameras, mirrorless cameras, video cameras and/or similar devices may be used in connection with the subject system. The subject system is preferably mounted on a conventional security post, either tethered or untethered that may be further connected with respect to a retail security and alarm system.

The figures show embodiments of a camera display system for mounting on a retail shelf. Although the system is particularly adaptable to a traditional store shelf, the system is not limited to a traditional horizontal shelf arrangement and may be used in connection with any suitable retail display including a store fixture, a kiosk, a promotional display, a wall, a piece of furniture, and/or any other suitable setting a consumer may encounter. As such, the term “store shelf” is not intended to be limited to the shelves that you would find in the aisles of a grocery store.

As shown in FIGS. 1-6, the system 20 preferably includes a rail mount 30, shown in isolation at FIGS. 3 and 4, for affixing to a camera 25. The rail mount 30 preferably attaches to a camera using a security screw, such as connected to the tripod receiver on the bottom of the camera 25. The rail mount 30 may thus include a number of apertures 32 for adaptation to a variety of cameras and tripod mounts. The rail mount 30 includes rails 34 and 36 on opposing side edges. The rail mount 30 may further include an elbow 38 at one end and extending below the attachment surface 35 of rail mount 30. The elbow 38 engages a camera rail and/or a base as described below, preferably for locking the rail mount 30 in place on the base.

A camera rail 40, shown in isolation in FIG. 5, is preferably affixed to a base 50, which is attachable to or integrated with a security post 52. The camera rail 40 may be integrated to base 50, but is shown as a separate piece. The camera rail 40 preferably includes an internal channel that is engageable with the rail mount 30. As illustrated, the cameral rail 40 includes an internal channel 45, generally formed by two side channels 42 and 44 on opposite sides of the camera rail 40. Each of the two side channels 42 and 44 is configured to receive one of the rails 34 and 36. A stop 46 may be formed at a distal edge of the internal channel 45 to provide a limit for the rail mount 30 to slide into the camera rail 40. The internal channel 45 is preferably engageable with the elbow 38 of the rail mount 30 to permit a secure connection between the rail mount 30 and the camera rail 40.

As shown in FIGS. 1 and 2, the rail mount 30 may extend into the rail 40 and then be together mounted on a security post 52 through the base 52. The base 52 may include a push lock, and desirably a keyed push lock 60, that is extendable from the base 50 and into an opening 54 in the elbow 38 of the rail mount 30.

Push lock 60 can be engaged between the camera rail 40 and the rail mount 30 to permit a locking attachment. In a preferred embodiment, the push lock 60 is lockable without a key but requires the key 62 to unlock and detach the rail mount 30, and thus the camera 25, from the camera rail 40. The lock 60 is secured to a bottom side of the base 50 via a lock enclosure 64.

As further shown in FIGS. 1 and 2, and separately in FIG. 6, a camera shroud 70 may extend from and/or be positioned to attach to the rail mount 30, the rail 40, and/or the base 50. The camera shroud 70 includes a rounded receiver opening 72 for, and extending around the camera lens. The camera shroud 70 is preferably fixed into place relative to the attached camera 25 and shrouds access to a lens release button 27 that is common on camera bodies having removable lenses. The camera shroud 70 thus covers and prevents removal of the lens from the camera body. The shroud 70 can additionally extend around one or both sides, and even the top, of the camera 25 as needed. Likewise, the rail mount 30 preferably prevents access to the bottom of the camera 25 where a battery and/or memory card may be contained.

The shroud 70 may be integrated with one of the rail mount 30, the rail 40, or the base 50. As illustrated, the camera shroud 70 is a separate component that fits between the rail mount 30 and the camera 25. As shown in FIG. 6, the shroud 70 includes an opening 74 as a pass-through for the security screw discussed above that goes into the tripod mount of the camera. The shroud 70 further includes a shroud rail 76 that fits against the rail mount 30, preferably an outer or exposed side of the rail mount 30.

As will appreciated, various sizes, shapes, and configurations are available for the components described above, such as depending on need. As an example, the camera rail can include a channel at an end opposite the lock, with the rail mount including a corresponding end rail, whereby the rail mount inserts into the end channel and is held in place by the elbow and lock. The lock can alternatively be a cam-based lock instead of a push lock.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. A camera display system for mounting on a retail shelf, the camera display system comprising:
a base;
a mount configured to attach to a camera, wherein the mount is connectable and is lockable with respect to the base; and
a camera shroud positioned over one or more releases of the camera, the camera shroud affixed to the base and/or the mount.

2. The camera display system of claim 1, wherein the camera shroud is secured between the rail mount and the camera.

3. The camera display system of claim 1, wherein the camera shroud extends upwards from the base and/or the mount to cover the one or more releases of the camera.

4. The camera display system of claim 1, wherein the camera shroud includes a curved receiver configured to receive a lens of a camera.

5. The camera display system of claim 1, wherein the base includes a channel, and the mount includes a rail configured to fit into the channel.

6. The camera display system of claim 5, further comprising a camera rail including the channel, wherein the camera rail is configured to attach to the base.

7. The camera display system of claim 5, wherein the rail slides within the channel.

8. The camera display system of claim 5, wherein the camera shroud is secured between the camera and the rail mount.

9. The camera display system of claim 1, wherein one of the base and the mount includes a lock, and an other of the base and the mount includes a lock receiver.

10. The camera display system of claim 9, wherein the base includes a channel, the mount includes a rail that slides into the channel, an end of the mount includes an elbow, and the elbow includes the lock receiver.

11. A camera display system for mounting on a retail shelf, the camera display system comprising:
a base including a camera rail;
a rail mount configured to attach to a camera, wherein the rail mount is slideable with respect to the rail and lockable with respect to the base and the rail; and
a camera shroud positioned over one or more releases of the camera, the camera shroud affixed to one or more of the camera rail, the base, and the rail mount.

12. The camera display system of claim 11, wherein the camera shroud is secured between the rail mount and the camera.

13. The camera display system of claim 11, wherein the camera shroud extends upwards from the base and the rail mount to cover the one or more releases of the camera.

14. The camera display system of claim 11, wherein the camera shroud includes a curved receiver configured to extend partially around a lens of a camera.

15. The camera display system of claim 11, wherein the camera rail includes opposing channels on opposing sides, and the rail mount includes opposing rails each configured to fit into one of the opposing channels.

16. The camera display system of claim 15, wherein the camera rail is separate from and configured to attach to the base.

17. The camera display system of claim 15, wherein the opposing rails slide within the opposing channels.

18. The camera display system of claim 15, wherein the camera shroud includes a shroud rail configured to fit against the rail mount, and the camera shroud is secured between the camera and the rail mount.

19. The camera display system of claim 15, wherein one of the base and the rail mount includes a lock, and an other of the base and the rail mount includes a lock receiver.

20. The camera display system of claim 19, wherein the rail mount slides within the opposing channels, an end of the rail mount includes an elbow configured to extend around an end of the cameral rail, and the elbow includes the lock receiver.
